(19) United States
(12) Patent Application Publication
(10) Pub. No.: US 2005/0267776 A1
(43) Pub. Date: Dec. 1, 2005

(54) Combo kit and method of providing a combo kit

(76) Inventors: David A. Selby, Oconomowoc, WI (US); Michael W. Kirby, Mequon, WI (US); Shaun Horan, Muskego, WI (US)

Correspondence Address: MICHAEL BEST & FRIEDRICH, LLP, 100 E WISCONSIN AVENUE, MILWAUKEE, WI, 53202, US

(21) Appl. No.: 11/063,675

(22) Filed: Feb. 23, 2005

Related U.S. Application Data
(63) Continuation-in-part of application No. 10/646,610, filed on Aug. 22, 2003.

(51) Int. Cl. G06F 17/60

(52) U.S. Cl. 705/1

(57) ABSTRACT

A combo kit selection system and methods operable to facilitate the configuration and purchase of a power tool combination kit. In some aspects, the method of providing the power tool combo kit provides the economic benefit of purchasing power tools in a combo kit while providing the flexibility of purchasing power tools individually.

### RELATED APPLICATIONS

This application is a continuation-in-part patent application of and claims priority to U.S. patent application Ser. No. 10/646,610, filed Aug. 22, 2003. The contents of application Ser. No. 10/646,610 are hereby incorporated by reference.

### FIELD OF THE INVENTION

This invention relates to power tools and, more particularly, to methods for providing a power tool combo kit.

### SUMMARY OF THE INVENTION

Power tools have previously been provided and sold as individual tools. Some power tools have been combined together to be provided and sold as a combo kit. Existing power tool combo kits are limited in the number of power tools that are available and include limited combinations of power tools. Combo kits are particularly popular with cordless power tools, which are interchangeably usable with a single rechargeable battery. Combo kits for cordless power tools help customers avoid purchasing redundant battery chargers and excess rechargeable batteries that may be used with the multiple power tools of the combo kit.

The contents of prior art power tool combo kits are determined by the manufacturer and are pre-packaged without direct input from a customer. Under this arrangement, several different combo kits must be developed and stocked, which may be costly and burdensome for the manufacturer and distributor. In addition, the customer may be unable to purchase a combo kit having the desired mix of power tools. While there are many possible combinations of power tools that may be included in a combo kit, existing combo kits provide a very limited number of power tool combinations. Also, existing power tool combo kits only provide a single power tool of each tool model.

The invention may generally include a method of purchasing a combination kit. The method comprises the act of selecting a plurality of items, generating a purchase request based on a configuration of the plurality of items as a combination kit, and purchasing the combination kit.

One independent embodiment of the invention may include a computer program embodied by a computer readable medium capable of being executed by a computer, the computer program for use in a combo kit selection system. The computer program comprises an item module operable to generate a list of items, and a module operable to configure a plurality of selected items from the list of items as a combination kit.

Another independent embodiment of the invention may include a method of automatically configuring a combination power tool kit. The method comprises the acts of selecting a plurality of items, determining whether the selected items qualify for a combination discount, if the selected items qualify for a combination discount, generating a combination kit configuration report including a single price for all of the selected items, and if the selected items do not qualify for a combination discount, generating a suggestion to modify at least one of the selected items.

Independent features and independent advantages of the invention will become apparent to those skilled in the art upon review of the following detailed description, claims and drawings.

### BRIEF DESCRIPTION OF THE DRAWINGS

FIG. 1A illustrates at least a portion of an available group of multiple power tools for a combo kit.

FIG. 1B illustrates at least a portion of an available group of multiple power tools for a combo kit.

FIG. 2 is a perspective view of a battery charger.

FIG. 3A is a perspective view of a battery charger.

FIG. 3B is a perspective view of a battery charger.

FIG. 4 is a perspective view of two constructions of a carrying case.

FIG. 5 illustrates at least a portion of an available group of multiple power tools for a combo kit.

FIG. 6 illustrates at least a portion of an available group of multiple power tools for a combo kit.

FIG. 7 is a diagram illustrating a grouping of power tools for a combo kit.

FIG. 8 is a diagram illustrating a grouping of power tools for a combo kit.

FIG. 9 is an illustration of a combo kit selection system according to one embodiment of the invention.

FIG. 10 is a user interface screen of the combo kit selection system of FIG. 9.

FIG. 11 is a user interface screen of the combo kit selection system of FIG. 9.

FIG. 12 is a user interface screen of the combo kit selection system of FIG. 9.

FIG. 13 is a user interface screen of the combo kit selection system of FIG. 9.

FIG. 14 is a user interface screen of the combo kit selection system of FIG. 9.

FIG. 15 is a user interface screen of the combo kit selection system of FIG. 9.

FIG. 16 is a user interface screen of the combo kit selection system of FIG. 9.

FIG. 17 is a user interface screen of the combo kit selection system of FIG. 9.

FIG. 18 is a user interface screen of the combo kit selection system of FIG. 9.

FIG. 19 is a user interface screen of the combo kit selection system of FIG. 9.

FIG. 20 is a user interface screen of the combo kit selection system of FIG. 9.

FIG. 21 is a user interface screen of the combo kit selection system of FIG. 9.

FIG. 22 is a user interface screen of the combo kit selection system of FIG. 9.

FIG. 23 is a user interface screen of the combo kit selection system of FIG. 9.

FIG. 24 is a user interface screen of the combo kit selection system of FIG. 9.

FIG. 25 is a user interface screen of the combo kit selection system of FIG. 9.

FIG. 26 is a user interface screen of the combo kit selection system of FIG. 9.

FIG. 27 is a user interface screen of the combo kit selection system of FIG. 9.

FIG. 28 is a combo kit ticket displayed by and/or printed from the combo kit selection system of FIG. 9.

FIG. 29 is flow chart illustrating the operation of the combo kit selection system of FIG. 9 according to one embodiment of the method of the invention.

FIG. 30 is a block diagram of a software program that can be used in the combo kit selection system of FIG. 9.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

Although references are made below to directions, such as left, right, up, down, top, bottom, front, rear, back etc., in describing the drawings, they are made relative to the drawings (as normally viewed) for convenience. These directions are not intended to be taken literally or limit the present invention in any form.

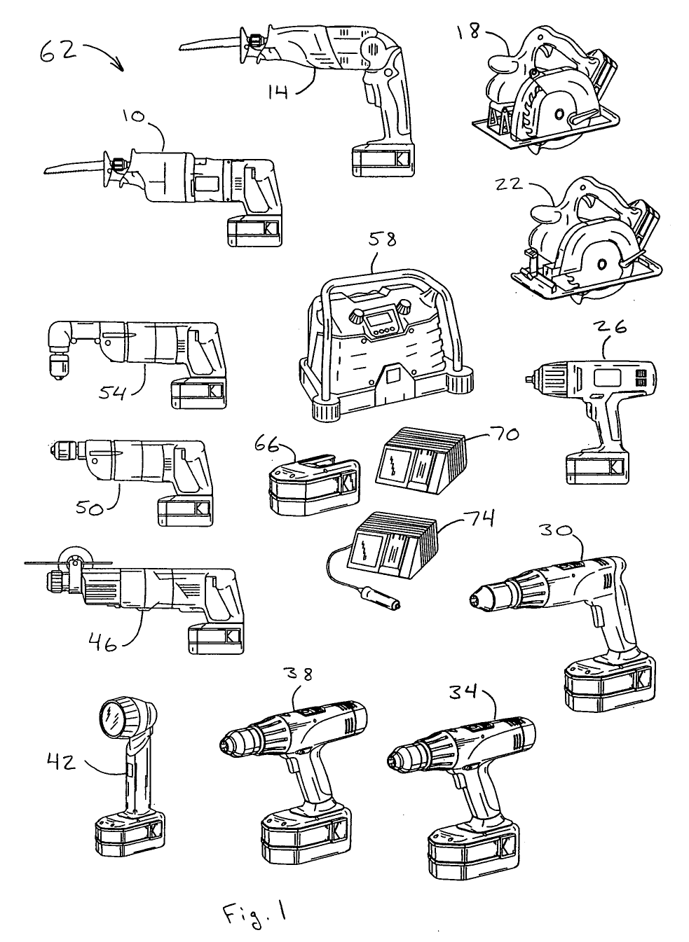

FIG. 1A illustrates multiple cordless power tools of various tool models. FIG. 1A illustrates a reciprocating saw 10, an angled reciprocating saw 14, a metal cutting circular saw 18, a circular saw 22, an impact wrench 26, an extended hammer-drill driver 30, a hammer-drill driver 34, a driver/drill 38, a work light 42, a rotary hammer 46, a D-handle drill 50, a right angle drill 54, and a portable radio 58. At least some of the power tools illustrated in FIG. 1A form at least a portion of an exemplary available group 62 of power tools. The available group may include other cordless power tools not illustrated in FIG. 1A. In FIG. 1A, all of the illustrated power tools in the available group 62 are cordless power tools, however, as described below, the available group 62 may also include corded tools.

FIG. 1A illustrates a rechargeable battery 66, a battery charger 70, and a car adaptable battery charger 74. The battery 66 is interchangeable and connectable with at least one of and, in the illustrated construction, each of the cordless power tools of the available group 62 to provide power for the respective power tool. The battery 66 is also connectable with the battery chargers 70, 74 to be recharged. The battery chargers 70, 74 shown in FIG. 1A have a generally horizontal body.

FIG. 1B illustrates a second rechargeable battery 66′ that may be compatible with at least one of the cordless power tools of at least a portion of the available group 62. The batteries 66 and 66′ may be operable and compatible with different tools from the available group 62. The batteries 66 and 66′ may have a similar appearance, as shown in FIGS. 1A and 1B, however, the batteries 66 and 66′ may have some differences. For example, the battery 66 may be a battery of a first voltage (for example, 18V) which is compatible with the driver/drill 38 which operates at about the first voltage (for example, about 18V), and the battery 66′ may be a battery of a second voltage (for example, 28V) which is compatible with the circular saw 22′ which operates at about the second voltage (for example, about 28V). Using this example, the 18V battery 66 may not be compatible with 28V circular saw 22′, and the 28V battery 66′ may not be compatible with the 18V driver/drill 38. Both the 18V battery 66 and the 28V battery 66′ may be compatible with the battery charger 70 or 70′. The combo kit may include one or more batteries 66, 66′ of varying voltages, such as, for example, 18V, 28V, etc. In other constructions, the batteries 66 and 66′ may have different appearances. Also, in other constructions, some of the power tools may be compatible with both batteries 66 and 66′.

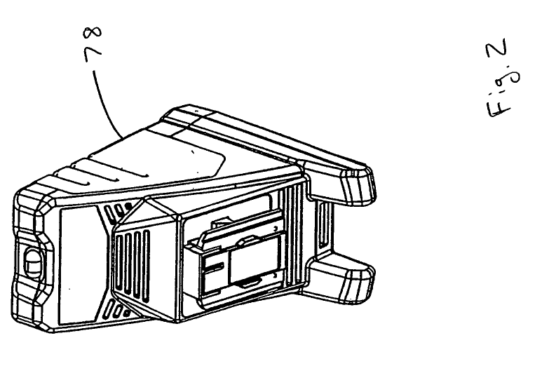

FIG. 2 illustrates an alternative battery charger 78 having a generally vertical body. The vertical battery charger 78 is also connectable with the batteries 66 and 66′ (FIGS. 1A and 1B) to recharge the battery 66. The vertical battery charger 78 includes the same type of mounting portion that engages the battery 66, 66′ as the horizontal battery charger 70 (FIG. 1A or 1B). However, in the vertical battery charger 78, the internal components are configured in the relatively vertical body arrangement instead of the generally horizontal body arrangement.

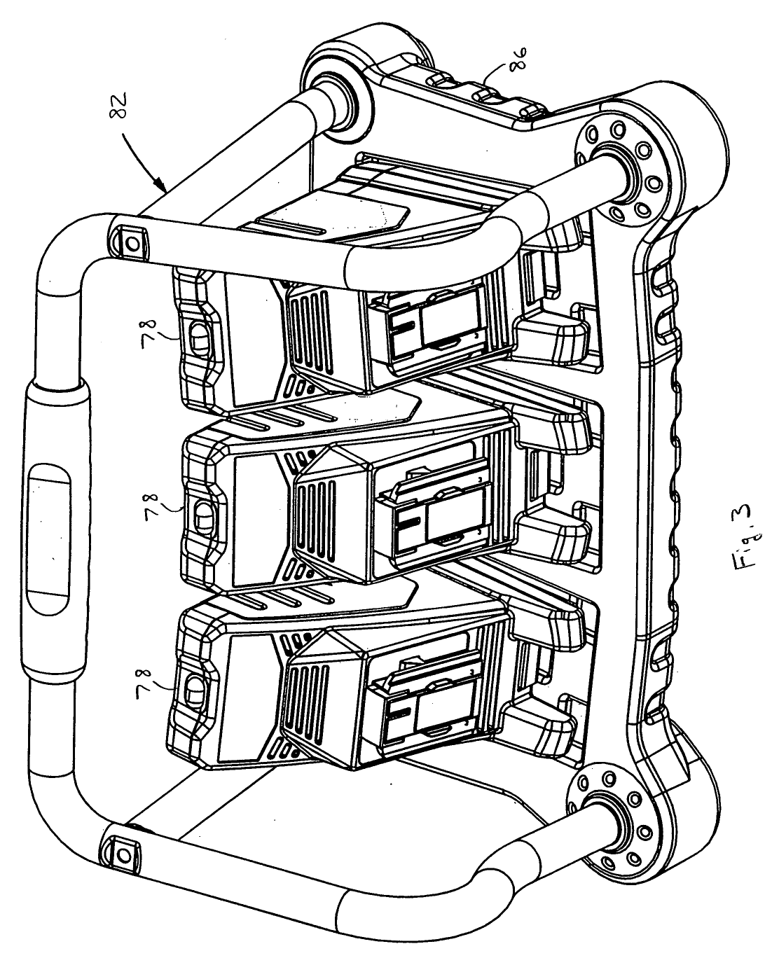

FIG. 3A illustrates a multi-bay battery charger 80 capable of simultaneously charging multiple batteries 66. The multi-bay charger 80 includes multiple mounting portions to simultaneously engage multiple batteries 66, 66′. An example of the battery charger 80, as shown in FIG. 3A, is illustrated and described in U.S. patent application entitled “BATTERY CHARGER”, filed on Nov. 7, 2002 and having Ser. No. 10/289,621, the entire contents of which are incorporated herein by reference.

FIG. 3B illustrates a multi-bay battery charger 82 capable of simultaneously recharging multiple rechargeable batteries 66 or 66′ (FIG. 1A or 1B). The multi-bay battery charger 82 includes a carrying caddy 86 and multiple vertical battery chargers 78 connected to the caddy 86. The vertical configuration of the battery chargers 78 permit the chargers 78 to be connected in relatively close proximity to one another on the caddy 86 and minimize the over all width of the multi-bay charger 82. The multi-bay charger 82 may include a single cord to provide power to the multi-bay charger 82. Alternatively, each vertical battery charger 78 may be removed from the caddy 86 and may include its own cord to individually recharge a battery 66. An example of the battery charger 82, as shown in FIG. 3B, is illustrated and described in U.S. Provisional Patent Application entitled “BATTERY CHARGER AND ASSEMBLY”, filed on May 7, 2003 and having Ser. No. 60/468,566, the entire contents of which are incorporated herein by reference.

The horizontal battery charger 70, the vertical battery charger 78, and the multi-bay battery charger 82 all may include a power cord connectable to a standard AC current outlet to provide power to recharge the battery 66. The car adaptable battery charger 74 may include a power cord connectable to a DC current power source, such as a car cigarette lighter, to provide power to recharge the battery 66. Any of the chargers 70, 74, 78, 82 may be used to recharge the battery 66, 66′. In some aspects, one battery charger may charge battery 66 but not battery 66′, and another battery charger may charge battery 66′ but not battery 66. In some aspects, one battery charger may charge both batteries 66, 66′.

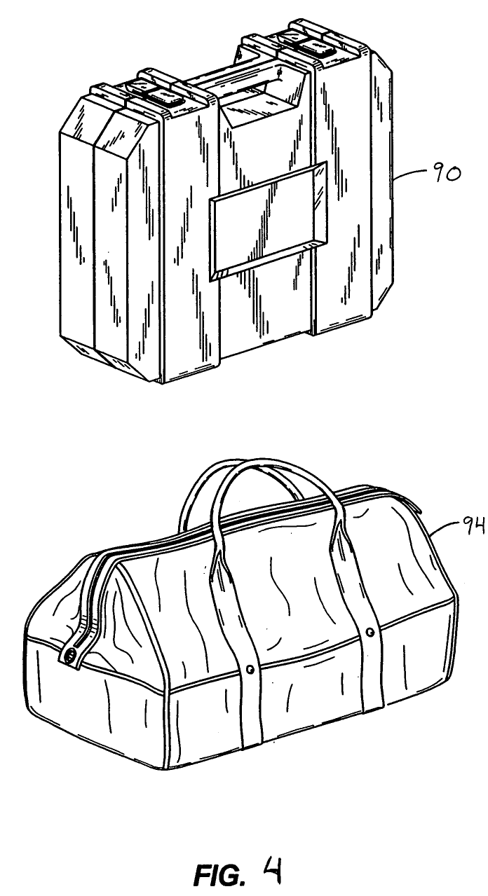

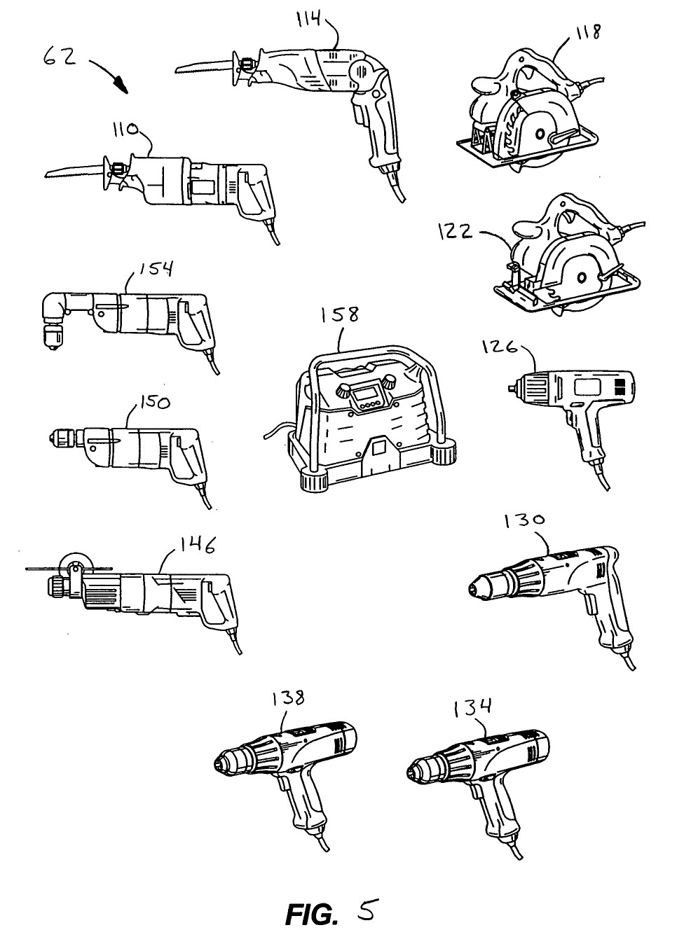

FIG. 4 illustrates a carrying case 90 having sufficient space to store the tools of the combo kit. The carrying case 90 may include a hard rigid case, as shown in FIG. 4. Alternatively, the carrying case may include a bag 94, a bin, a mounted storage holder, a rack, or other similar storing or transporting apparatus. The carrying case 90 may be designed to store the specific power tools of the desired combo kit. Additionally, the carrying case 90 may only carry the rechargeable battery 66 and battery charger 74, and the power tools may be stored or transported separately. The carrying case 90 may also only carry a portion of the power tools of the combo kit.

In some aspects, the available group 62, as shown in FIG. 1A or 1B, may include the rechargeable battery 66 or 66′, the horizontal battery charger 70, the car adaptable battery charger 74, the vertical battery charger 78 (FIG. 2), and the multi-bay battery charger 82 (FIG. 3B). The available group 62 may also include the carrying case 90, 94 (FIG. 4). In some aspects, the combo kit may include a starter kit including the battery 66 or 66′, at least one of the battery chargers 70, 74, 78, 80, 82 and the carrying case 90, 94. The starter kit may form the foundation of the combo kit, and various power tools of the combo kit may be selected from the available group 62 to be added to the starter kit and complete the combo kit.

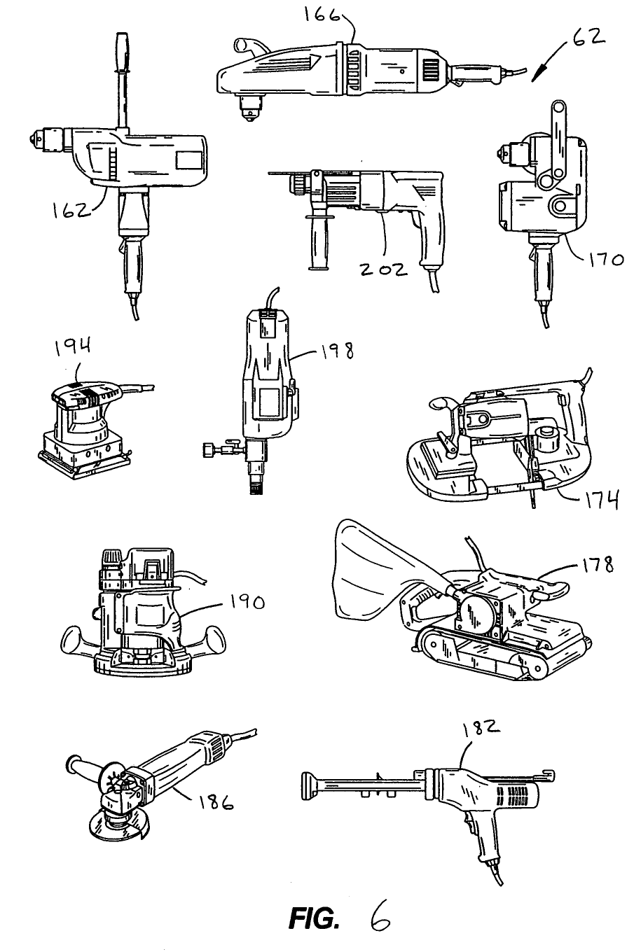

As discussed above and shown in FIGS. 1A and 1B, the available group 62 may include cordless power tools, however, the available group 62 may also include corded power tools. FIGS. 5-6 illustrate various corded power tools that may be included in the available group 62. FIG. 5 illustrates an exemplary available group 62 including a reciprocating saw 110, an angled reciprocating saw 114, a metal cutting circular saw 118, a circular saw 122, an impact wrench 126, an extended hammer-drill driver 130, a hammer-drill driver 134, a driver/drill 138, a rotary hammer 146, a D-handle drill 150, a right angle drill 154, and a portable radio 158. FIG. 6 illustrates the available group 62 including a super hole-shooter drill 162, an extended hole boring drill 166, a hole boring drill 170, a portable band saw 174, a belt sander 178, a caulk gun 182, a sander/grinder 186, a grinder 190, an orbital sander 194, a coring drill 198, and a rotary hammer 202. It should be understood that the available group 62 may include other similar corded power tools not illustrated in the Figures. In some aspects, the available group 62 may include other types of tools, such as pneumatic tools and accessories, and may include other equipment such as generators, lawn and garden equipment, and electronic equipment.

The available group 62 may include cordless power tools, as shown in FIGS. 1A and 1B, and may also include corded power tools, as shown in FIGS. 5-6. The combo kit may also include a combination of both cordless power tools and corded power tools. FIGS. 1A-1B and 5-6 only illustrate a single power tool of each tool model. The available group 62 includes a substantially inexhaustible supply of power tools, and may include multiple power tools of the same tool model. The combo kit may include virtually limitless combinations of the various power tools of the available group, including multiple power tools of the same tool model. For example, the combo kit may include five drills 38, three reciprocating saws 10, etc. Almost any conceivable combination of power tools from an available group 62 may be combined into the combo kit.

For the purposes of this invention, various classifications of power tools will be defined. The term “power tools” generally represents all power tools, including but not limited to, bandfiles, caulk and adhesive guns, circular saws, D-handle drills, driver/drills, hammer-driver drills, impact wrenches, jig saws, radios, rotary hammers, reciprocating saws, screwdrivers, work lights, cut-off machines, coring drills, drain cleaners, hoists, trolleys, slings, polishers, routers, sanders, grinders, band saws, hack saws, chain saws, miter saws, shears, vacuums, power tool accessories, and other similar portable or non-portable power equipment. The term “power tools” may also include both corded and cordless power tools.

“Power tools” may be sub-classified into multiple “types of power tool.” A “type of power tool” is a specific power tool, such as a drill, or other power tools from the preceding list. Multiple manufacturers generally make power tools of the same “type of power tool,” and a single manufacturer may make multiple versions of a “type of power tool.” A “type of power tool” may be sub-classified into multiple “tool models.” A “tool model” is a specific type of power tool and represents individual power tools that are substantially identical to other individual power tools of the same “tool model.” A “tool model” is generally unique to a manufacturer, and multiple “tool models” may be classified under the same “type of power tool.” A “tool model” is generally referred to by a model number or catalog number. For example, a drill may be a “type of power tool”, but there may be multiple “tools models” of drills.

In the described example, the method acts may be listed in an order, however, it is not necessary to perform the acts in the illustrated order to perform the method of the invention. Also, it is not necessary to perform all of the described acts to practice the invention. It should be understood that the method of the invention is defined in the claims and the figures and detailed description merely provide examples of some aspects of the method.

The method includes multiple acts performed by the provider to provide the combo kit to the customer. The method may include interaction from the customer to select which tools are in the combo kit, and the customer may perform some acts of the method. The provider includes any supplier of the power tool combo kit and may include a manufacturer, a distributor, a retailer, or other parties in the transaction of the combo kit. The customer includes any recipient of the power tool combo kit, and may include a distributor, a retailer, an intermediary, an end purchaser, or any other parties in the transaction of the combo kit.

The provider provides an available group 62 of power tools. The available group includes multiple power tools of various tool models. The available group may also include multiple power tools of the same tool model and may include a relatively unlimited supply of power tools of the same model. FIGS. 1A-1B and 5-6 illustrate examples of power tool models that may be included in the available group.

In some aspects, the customer selects which power tools from the available group 62 are desired in the combo kit, and the customer generates a desired request or customer selection of the desired or requested power tools from the available group. The desired request may include a wide variety of combinations of various power tools from the available group 62 and, in some aspects, may include multiple power tools of the same tool model. The desired request permits the customer to customize the combo kit for his/her individual needs. For example, a customer that repeatedly performs a single task may require multiple power tools of the same tool model instead of a variety of power tools representing different tool models. For example, a customer that is a drywall contractor may have a large demand for drywall screwdrivers and a lower demand for other tools. In this case, the customer can request a combo kit with multiple drywall screwdrivers.

The desired request may also include additional batteries 66 or 66′, battery chargers, or other power tool accessories. Additional batteries 66 or 66′ may be helpful for a customer that must continually use the power tool while the battery 66 or 66′ requires recharging. The customer may customize the combo kit after determining his/her specific need for additional batteries, battery chargers, and other accessories.

The provider receives the desired request from the customer and selects a selected group of selected power tools in response to the desired request. The selected group includes multiple power tools from the available group and corresponds to or matches the desired request. If a requested tool is unavailable, the provider may suggest, for customer approval, or provide another similar power tool of the same type. In some aspects, the customer selection and the selected group may include multiple power tools of the same tool model. The selected group will eventually be part of the combo kit.

The provider provides the combo kit including the selected group of power tools. Power tool accessories, such as batteries and battery chargers, may be included within the selected group or may be provided separately as part of the combo kit. The provider may also provide the starter kit that may include batteries 66, 66′, battery chargers 70, 74, 78, 82, and/or the carrying case 90 or bag 94. The starter kit may be combined with the selected group to form the complete combo kit.

In some aspects, the combo kit may include cordless power tools. When the combo kit includes cordless tools, the combo kit may also include the battery charger 70, 74, 78, 82 and battery 66 and/or 66′ that is interchangeable with at least one of the cordless power tools of the combo kit and may be used to power at least one of the power tools of the combo kit. The battery 66 or 66′ is connectable to the battery charger 70 to recharge the power supply of the battery 66 or 66′. The battery charger 70 may include the single bay charger 70, 74, 78, as shown in FIGS. 1-2, the multi-bay charger 80, as shown in FIG. 3A, and/or the multi-bay charger 82, as shown in FIG. 3B. The provider provides the battery charger 70, 74, 78, 80, 82 and rechargeable battery 66 and/or 66′.

In some aspects, the combo kit may include the carrying case 90 having sufficient space to store the selected tools of the combo kit. The provider may provide the carrying case 90 to the customer as part of the combo kit or as an individual unit separate from the combo kit.

In some aspects, the combo kit may also include power tool accessories, such as a belt clip, a light, a bit holder, a blade holder, a level, blades, bits, or other similar accessories for use with power tools. The power tool accessories may be included as part of the available group and may be selected by the customer.

The combo kit is a single purchase unit, meaning that the combo kit is registered as a single entity during purchase. The combo kit is not registered as multiple tools sold as multiple units grouped together in a single sale. For example, in a sale involving a printed receipt, the combo kit will be listed as a single purchase item on the receipt, though it may identify selected components of the combo kit. The single purchase unit may be used for tracking sales and inventory of the power tools.

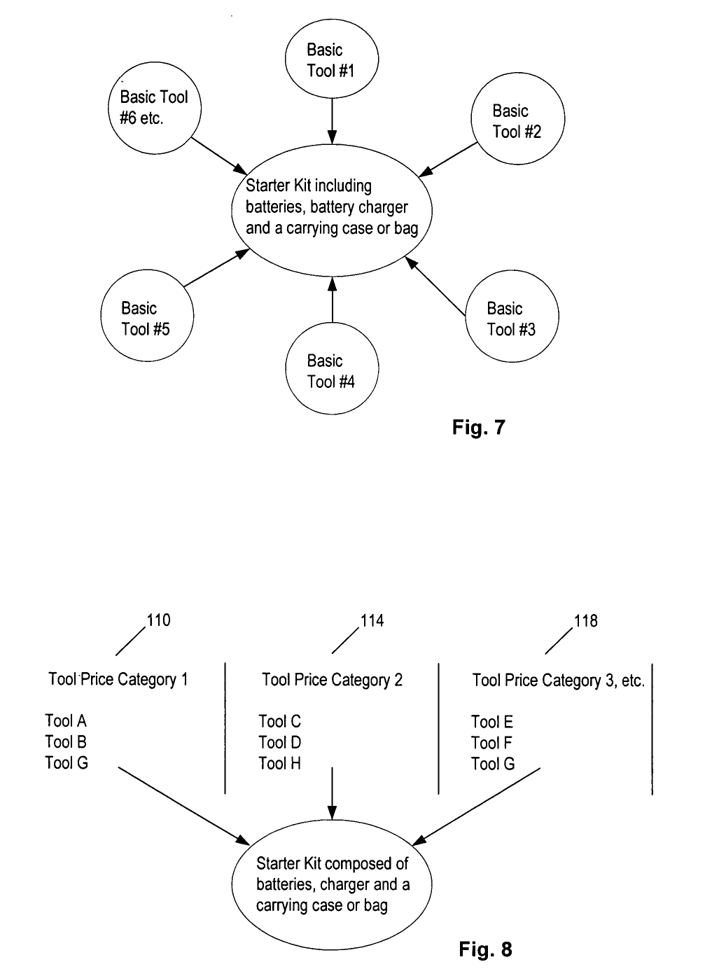

Since the combo kit may include various combinations of power tools, the pricing for the combo kit may depend on many factors, including the type and quantity of power tools in the combo kit. FIG. 7 illustrates a version of the method for providing a cordless power tool combo kit in which the provider provides a starter kit for the customer. The starter kit includes at least one rechargeable battery, a battery charger, and may also include the carrying case 90 or bag 94. The customer selects which power tools are included in the combo kit, and the provider then provides the complete combo kit including the starter kit and the power tools chosen by the customer. The price of the combo kit will depend on which power tools are included in the combo kit, and each tool model may attribute a certain portion of the price for the combo kit. For example, a drill of a specific tool model may attribute a first amount to the overall price of the combo kit and a reciprocating saw of a specific tool model may attribute a second amount to the overall price of the combo kit. Of course, the exact amount attributed to each tool model may differ from this example and may be determined by the provider.

FIG. 8 illustrates another version of the method for providing a cordless combo kit in which the available group may also be divided into multiple sub-groups, such as a first sub-group 210, a second sub-group 214 and a third sub-group 218, to determine pricing for the combo kit. Each sub-group may include power tools of multiple tool models and may define a tool price category. The price of the combo kit may be determined in response to the number of power tools selected from each sub-group 214, 214, 218. For example, a combo kit comprising a certain number of power tools from each sub-group may have a first price, while a combo kit comprising a different number of power tools from each sub-group may have a second price.

In some aspects, the portion of the price of the combo kit attributed to each power tool may be the same for each power tool from the same sub-group. For example, each power tool in the first sub-group 210 may attribute a first amount to the price of the combo kit, each power tool in the second sub-group 214 may attribute a second amount to the price of the combo kit, and each power tool in the third sub-group 218 may attribute a third amount to the price of the combo kit.

The sub-groups 210, 214, 218 may be classified by types of power tools. For example, the first sub-group 210 may comprise drills, the second sub-group 214 may include reciprocating saws, the third sub-group 218 may include circular saws. Using this example, a combo kit having two drills, three reciprocating saws, and two circular saws may have a first price, and a combo kit having a different combination of power tools may have a second price.

Alternatively, the sub-groups 210, 214, 218 may be grouped based on the level of features of the power tool. For example, the first sub-group 210 may include entry level power tools of multiple tool models, the second sub-group 214 may include power tools of multiple tool models having additional features in comparison the first sub-group 210, and the third sub-group 218 may include power tools of multiple tool models having additional features in comparison to the second sub-group 214.

In some aspects, each sub-group 210, 214, 218 may include power tools of an individual tool model. For example, every power tool of the first sub-group 210 would be substantially the same tool model. This classification may include a relatively large number of sub-groups and may provide additional flexibility in pricing for the combo kit.

In some aspects, the portion of the price of the combo kit attributed to each power tool may decrease for each additional power tool added to the combo kit. For example, the first power tool selected may attribute a first amount to the price of the combo kit, the second power tool selected may attribute a second amount to the price of the combo kit, and the third power tool selected may attribute a third amount to the price of the combo kit, in which the second amount is less than the first amount, and the third amount is less than the second amount. The pricing may also be stepped to provide a price break after a fixed number of power tools. For example, the first two power tools may attribute a first amount to the price of the combo kit, and the next two power tools may attribute a reduced amount to the price of the combo kit. Pricing may also include a minimum number of power tools selected for the combo kit.

The combo kit may include other corded and/or cordless equipment other than power tools. For example, the available group may include lawn and garden equipment, electronic equipment, audio and video equipment, cell phones, PDAs, e-organizers, computers, or other similar equipment. For cordless equipment, the equipment may share the same power source including batteries and battery chargers.

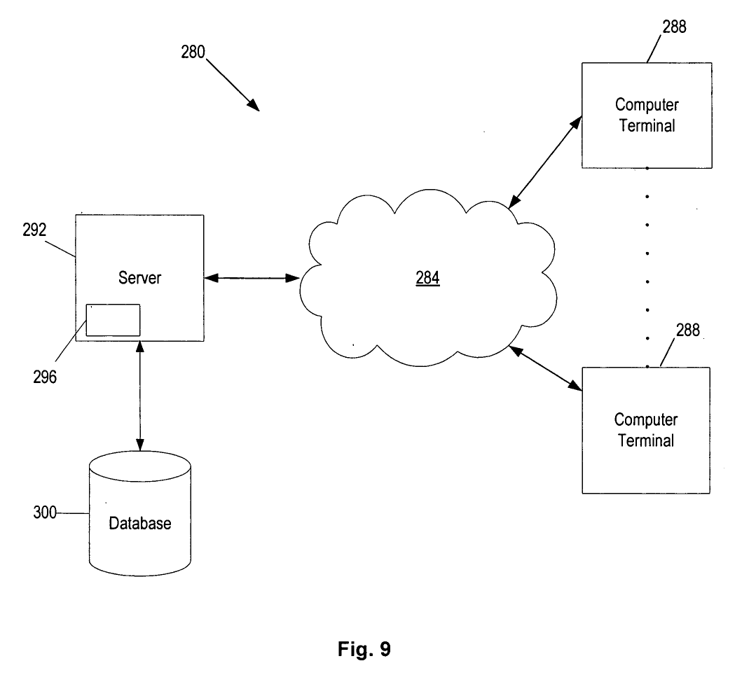

Additional independent aspects of the invention include other methods of selecting a combo kit. For example, the combo kit can be selected and automatically configured via a computer and network. FIG. 9 illustrates a combo kit selection system 280 according to one independent embodiment of the invention.

The combo kit selection system 280 includes a network 284, which communicates with a computer terminal 288 and a server 292. The network 284 can be built according to any networking technology or topology or combinations of technologies and topologies and can include multiple sub-networks. Connections between the systems shown in FIG. 9 can be made through local area networks (“LANs”), wide area networks (“WANs”), public switched telephone networks (“PSTNs”), Intranets, the Internet, or any other suitable networks.

The combo kit selection system 280 includes a client system, such as the computer terminal 288. The client system can include fewer or more computer terminals 288 than illustrated in FIG. 9. The computer terminals 288 can include typical hardware such as a processor, I/O interfaces, and storage devices or memory. The computer terminals 288 can also include input devices such as a keyboard and a mouse. The computer terminals 288 can further include standard output devices, such as a monitor. In addition, the computer terminals 288 can include or be connected to and communicate with peripherals, such as a printer and a scanner. The computer terminals 288 can include software such as an operating system, a display application, a communications application, and other software as necessary or desired.

The computer terminals 288 can be located anywhere, such as in a residence, at a jobsite or work site, at a retail store (e.g., a kiosk) where the power tools and combo kits are advertised or otherwise available, and/or at a warehouse. The computer terminals 288 can be accessed by anyone that desires to view the availability of power tools and/or combo kits, obtain more information related to the power tools and/or combo kits, configure a combo kit, reserve a combo kit, rent or lease power tools or a combo kit, and/or purchase a combo kit or other tools and items that may be sold separately.

The combo kit selection system 280 includes a server system, such as the server 292. The server system can include fewer or more servers 292 than illustrated in FIG. 9. The server 292 can include an operating system for running various software programs and/or a communications application. The server 292 can be a standard Windows file server. The server 292 includes a software program 296 (discussed below) that operates to communicate with the network 284. The software program 296 also operates to communicate with and be accessed by the computer terminals 288.

The server system also includes a database 300. The database 300 stores data and information related to the power tools, combo kits, starter kits, batteries, battery chargers, carrying cases or bags and inventory, and consumables, such as building materials and power tool accessories (e.g., bits, blades, etc.).

The software program 296 includes a user interface that the user interacts with to view the availability of power tools and combo kits, obtain more information related to the power tools and combo kits, configure a combo kit, reserve a combo kit, rent or lease power tools or a combo kit, purchase a combo kit or other tools and items that may be sold separately and/or other tasks. The user interface includes a plurality of screens that display information, data, selections, prices, suggestions, options, accessories, etc. related to power tools and combo kits. The user accesses the computer terminal 288, which accesses the server 292 to display the various screens.

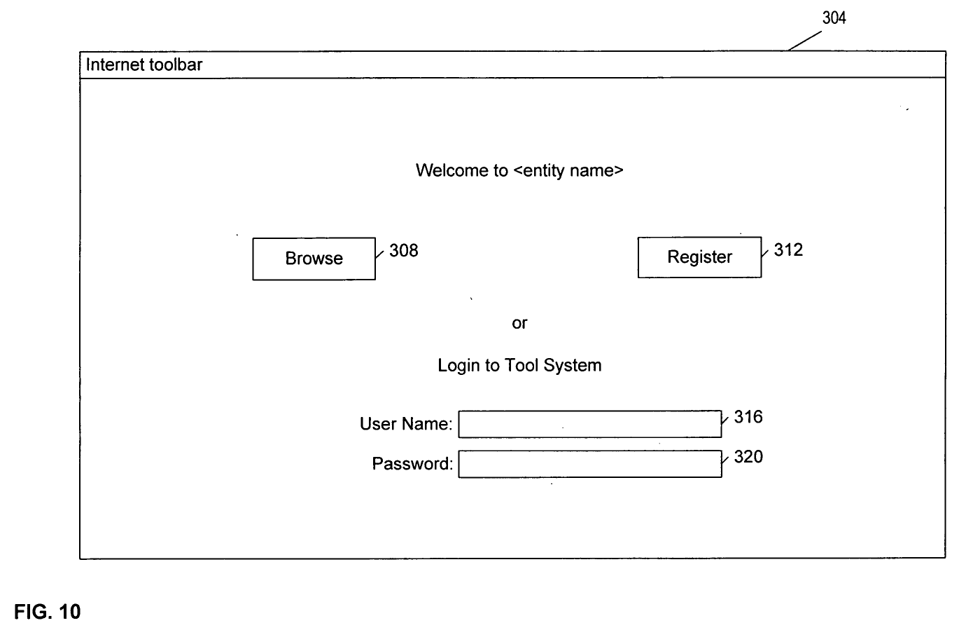

FIG. 10 illustrates an identification screen 304 that the user encounters when using the combo kit selection system 280. The user can access the functionality of the software program 296 as a guest by selecting a browse button 308 on the identification screen 304. The user can register by selecting a register button 312 and can select a user name and password for future access to the software program 296. The registration process can include various questions for the registrant to answer. For example, questions can include profession, years in the trade, tools previously purchased and/or used, brands of tools previously purchased and/or used, location of work sites, employer, etc. If the user previously registered, the user can enter a username in the designated username field 316 and a password in the designated password field 320.

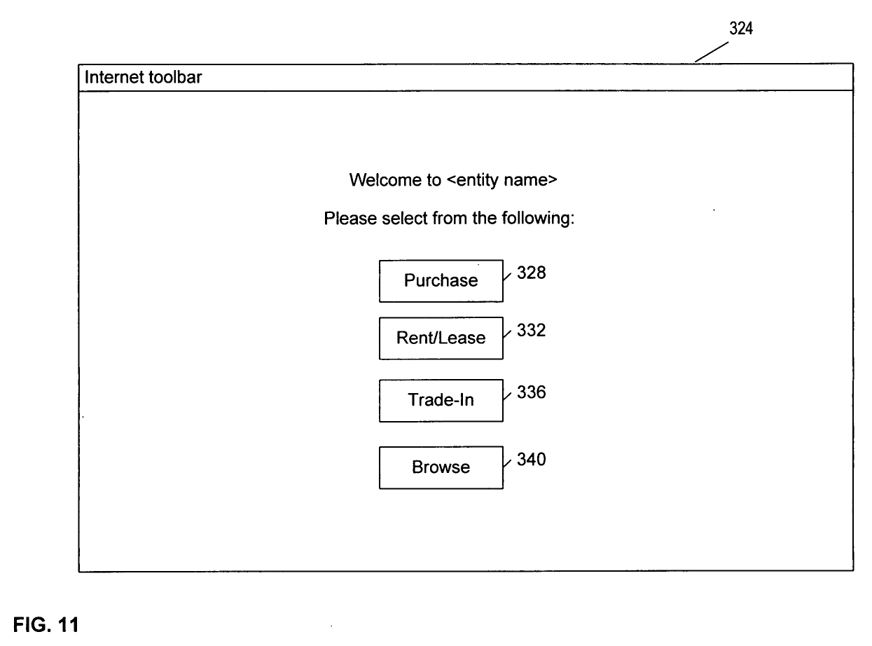

After the user selects the browse button 308 or enters an appropriate user name and password, the software program 316 presents an introduction screen 324 as illustrated in FIG. 11. The introduction screen 324 can include various options for the user. For example, the user can select from an option to purchase 328, an option to rent/lease 332, an option to trade-in 336, and an option to browse 340.

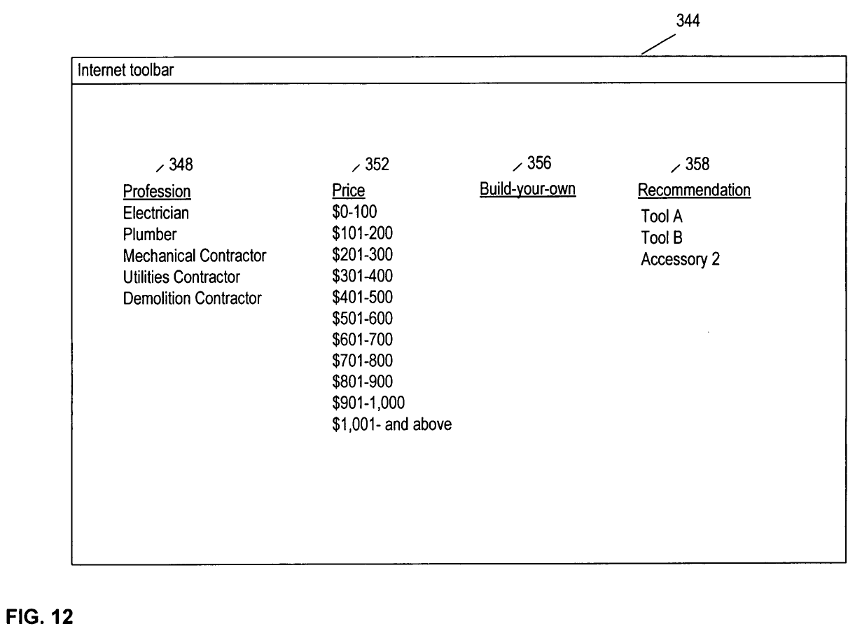

If the user selects the purchase option 328, screen 344 illustrated in FIG. 12 is displayed. The purchase option screen 344 can include various options for the user. The user can select from various options to help in the purchasing decision. For example, the user can select from an option to search for tools and combo kits by profession 348, an option to search for tools and combo kits by price 352, an option to build-your-own combo kit 356, and an option to review a recommended item(s) list 358. The recommended item(s) list 358 is available for a user that enters a user name and a password. The recommended item(s) list 358 can provide a list of recommended or suggested tools, combo kits, accessories, and/or consumables based on the user's prior purchases, rentals, browsing episodes, and/or other data acquired about the user based on user name and password use. The user can obtain additional information about the recommended item by selecting or clicking on the item in the list 358. The recommended item(s) list 358 is illustrated in FIG. 12, but could also be provided on any of the other screens discussed below.

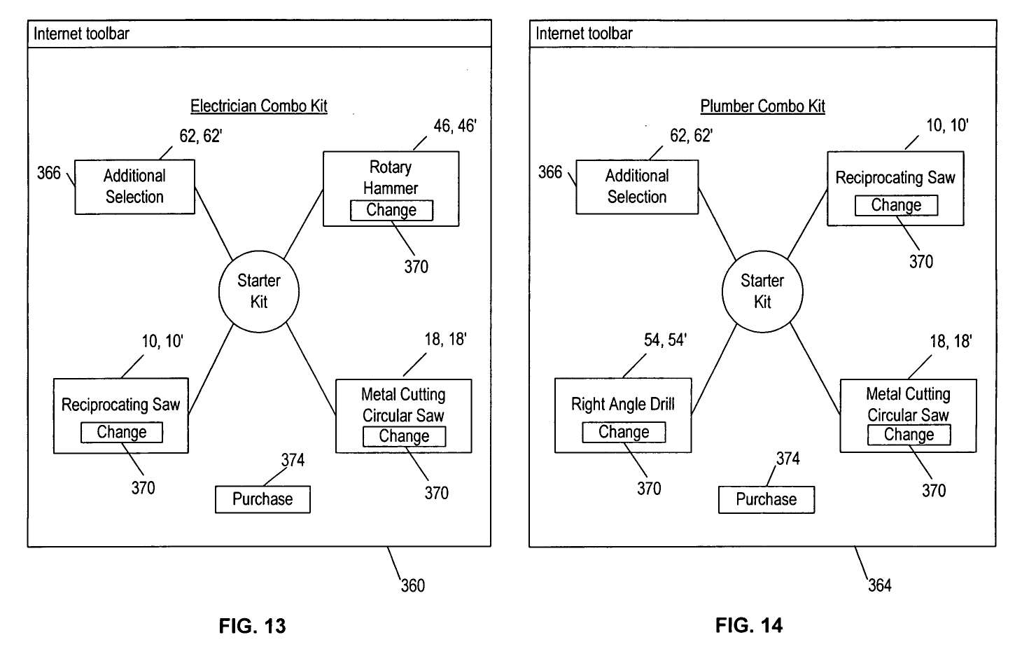

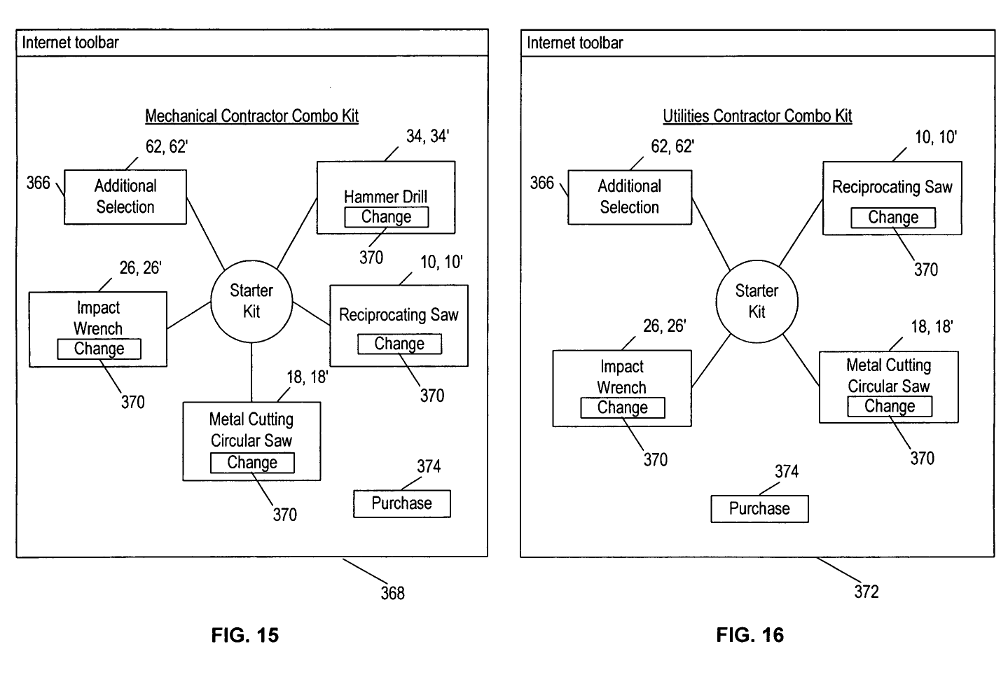

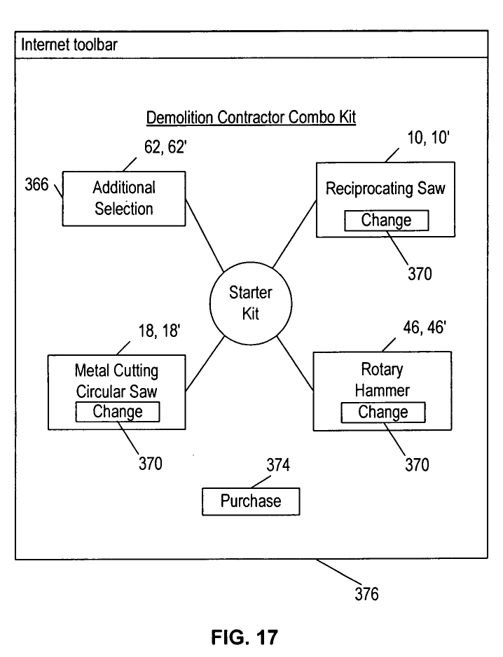

The option to search for tools and combo kits by profession 348 can include preconfigured combo kits for the specified professional as illustrated in screens 360-376 of FIGS. 13-17. For example, an electrician combo kit can include a starter kit (e.g., two batteries 66, 66′, a charger 70, 70′, 74, 74′, 78, 80, 82 and a case 90 or bag 94), a rotary hammer 46, 46′, a metal cutting circular saw 18, 18′, and a reciprocating saw 10, 10′. A plumber combo kit can include a starter kit (e.g., two batteries 66, 66′, a charger 70, 70′, 74, 74′, 78, 80, 82 and a case 90 or bag 94), a metal cutting circular saw 18, 18′, a reciprocating saw 10, 10′, and a right angle drill 54, 54′. A mechanical contractor combo kit can include a starter kit (e.g., two batteries 66, 66′, a charger 70, 70′, 74, 74′, 78, 80, 82 and a case 90 or bag 94), a metal cutting circular saw 18, 18′, a reciprocating saw 10, 10′, a hammer drill 34, 34′, and an impact wrench 26, 26′. A utilities contractor combo kit can include a starter kit (e.g., two batteries 66, 66′, a charger 70, 70′, 74, 74′, 78, 80, 82 and a case 90 or bag 94), a metal cutting circular saw 18, 18′, a reciprocating saw 10, 10′, and an impact wrench 26, 26′. A demolition contractor combo kit can include a starter kit (e.g., two batteries 66, 66′, a charger 70, 70′, 74, 74′, 78, 80, 82 and a case 90 or bag 94), a rotary hammer 46, 46′, a metal cutting circular saw 18, 18′, and a reciprocating saw 10, 10′.

The preconfigured combo kits for each profession can include an additional selection option 366. The additional selection option 366 includes access to a listing of all the available tools 62, 62′ regardless of the specified professional on each screen 360-376. In some aspects, the combo kit configured for a specified professional can be modified by clicking on or selecting a change button 370 to include a different tool that can be selected from all of the available tools 62, 62′. For example, one or more of the suggested tools for the specified professional can be removed and replaced with one or more of the other available tools 62, 62′. In one example, the electrician combo kit may be modified to remove the rotary hammer 46, 46′ and replaced with a work light 42, 42′. In another example, the electrician combo kit may be modified to remove the rotary hammer 46, 46′ and replaced with another reciprocating saw 10, 10′. In yet another example, the electrician combo kit may be modified to remove the rotary hammer 46, 46′ and replaced with a portable radio 158. In another example, the electrician combo kit may be modified to further include a second starter kit, a fourth (or more) tool, one or more batteries 66, 66′, one or more battery chargers 70, 70′, 74, 74′, 78, 80, 82, and one or more accessories.

The user can click on or select any of the objects or links in screens 360-376 to display more information about the specific tool and decide whether or not to add more tools, starter kits, and/or accessories to the specified combo kit. For example, the user can select the rotary hammer 46, 46′ on the screen 360 to learn more about the specifications of the rotary hammer and uses of the rotary hammer 46, 46′ in an electrical environment or other environments. In another example, the user can select the additional selection 62, 62′ on the screen 360 and a list of all available power tools 62, 62′ is displayed along with additional information of the available power tools and additional costs associated with including a particular tool to the electrician combo kit. The user can click on or select a purchase button 374 on the screens 360-376 to add the combo kit to a shopping cart that is well-known in the art.

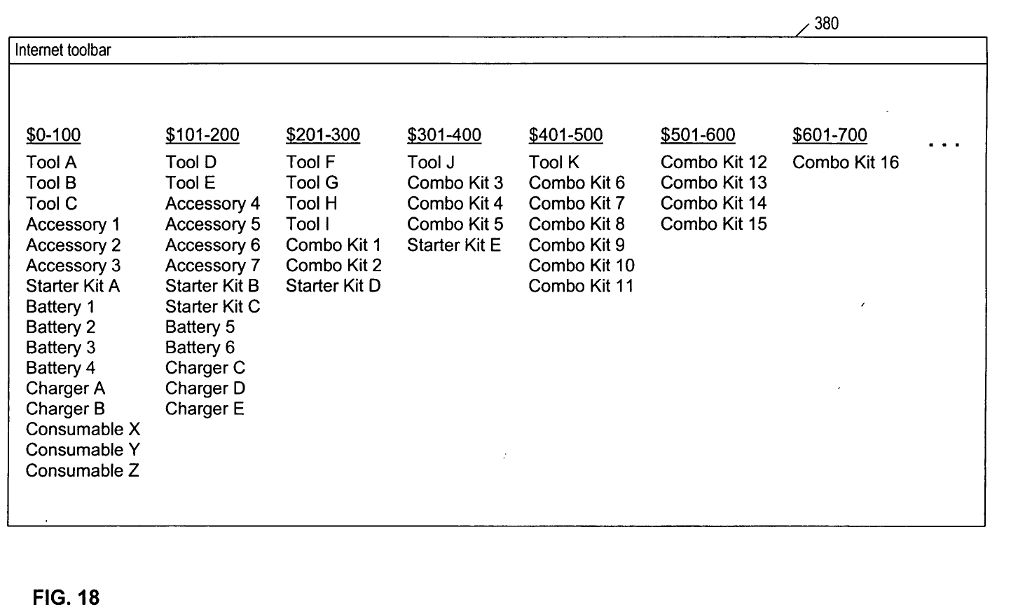

The option to search for tools and combo kits by price 352 includes a listing of all available tools 62, 62′, combo kits, starter kits, accessories, and consumables as illustrated in screen 380 in FIG. 18. The software program 316 can display separate screens for each price range or a single screen with all price ranges with the tools, combo kits, starter kits, and accessories that fall within each range.

Combo kits and starter kits may be preconfigured to fall within a specified price range. The preconfigured combo kits can include a plurality of different combinations made up of the available tools 62, 62′. The preconfigured combo kits can include from one to ten tools (or more), one or more starter kits, additional batteries 66, 66′, additional battery chargers 70, 70′, 74, 74′, 78, 80, 82, one or more accessories, and/or one or more consumables. The starter kits can include, for example, two batteries 66, 66′, a charger 70, 70′, 74, 74′, 78, 80, 82 and a case 90 or bag 94. The starter kits can also be modified to include more or fewer than two batteries, more than one charger, more than one case, bag, or both, and/or one or more consumables.

In some aspects, the preconfigured combo kits based on price can be modified to include a different tool that can be selected from all of the available tools 62, 62′, starter kits, accessories, one or more batteries 66, 66′, one or more battery chargers 70, 70′, 74, 74′, 78, 80, 82, the case 90 or bag 94, and consumables. For example, the Combo Kit 8 can be modified to include one or more tools from the available tools 62, 62′. In one example, one of the tools in the Combo Kit 8 can be removed and replaced with one or more of the other available tools 62, 62′. In another example, the Combo Kit 8 may include a starter kit and the Combo Kit 8 can be modified to further include a second starter kit. In yet another example, the Combo Kit 8 can be modified to include one or more batteries 66, 66′, one or more battery chargers 70, 70′, 74, 74′, 78, 80, 82, and one or more accessories.

The user can click on or select any of the objects or links in the screen 380 to display more information about the specific item. For example, the user can select the Tool D on the screen 380 to learn more about the specifications of the Tool D and uses of the Tool D. The page or screen that displays more information about the specific item can also include a purchase button or add-to-cart button.

The user can click on or select any of the listed combo kits in the screen 380 and can decide whether or not to modify and/or add more tools, starter kits, accessories, and/or consumables to the specified combo kit. For example, the user can select the Combo Kit 1 to learn more about the contents of the Combo Kit 1 and can modify the contents of the Combo Kit 1 to include a different tool that can be selected from all of the available tools 62, 62′, starter kits, accessories, one or more batteries 66, 66′, one or more battery chargers 70, 70′, 74, 74′, 78, 80, 82, the case 90 or bag 94, and consumables. The page or screen that displays information about the combo kit can be similar to the appearance and functionality of screens 360-376 as illustrated in FIGS. 13-17. The page or screen that displays information about the combo kit can also include a purchase button or add-to-cart button.

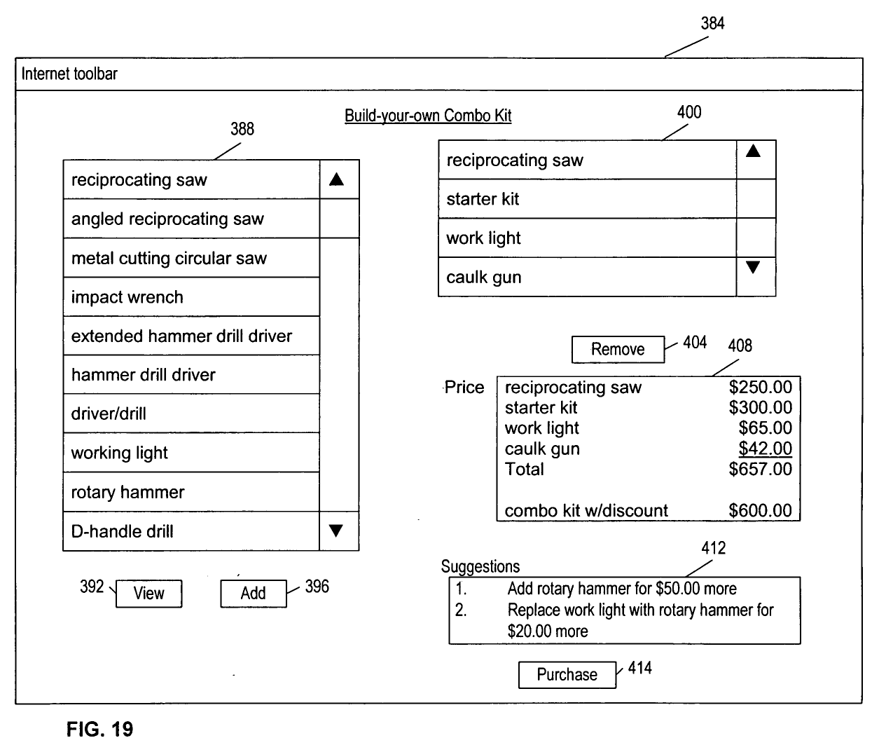

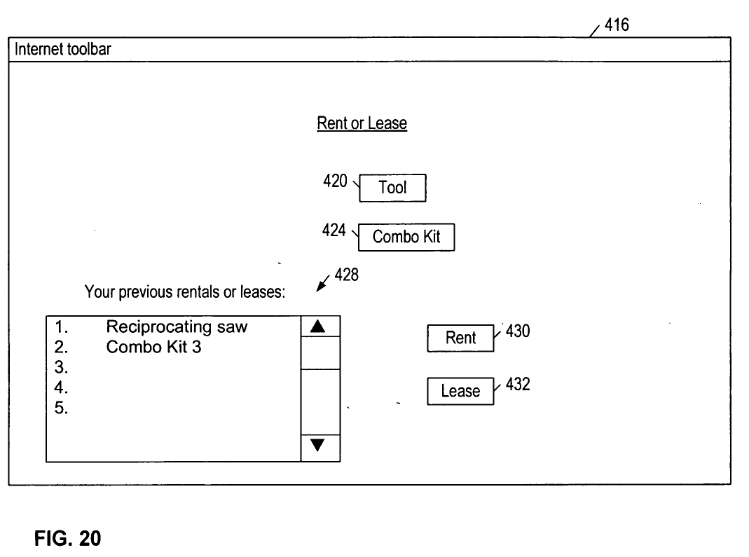

The option to build-your-own combo kit 356 includes a listing of all available tools 62, 62′, starter kits and accessories that can be selected as a part of a combo kit as illustrated in screen 384 in FIG. 19. The screen 384 includes a component section 388 that provides a listing of all tools and components that can be compiled to create a combo kit. The user can click on a view button 392 to view more information about the specific tool or component. The user can click on an add button 396 to add the tool or component to a selection section 400 that provides a listing of all tools and components that have been added to the combo kit. The user can remove tools or components from the combo kit by highlighting or selecting the item and selecting a remove button 404.

The screen 384 also includes a price section 408 that provides an itemized list of the cost for each tool or component in the created combo kit. The price section 408 also includes an indication of the amount of discount by creating the combo kit with the selected tools and/or components. The user can remove tools or components and add other tools or components to create a new combo kit. The price section 408 is updated to reflect the prices of the selected tools and components in the combo kit. The price section 408 can also indicate or identify if a particular tool or component is specially priced, such as a sale price.

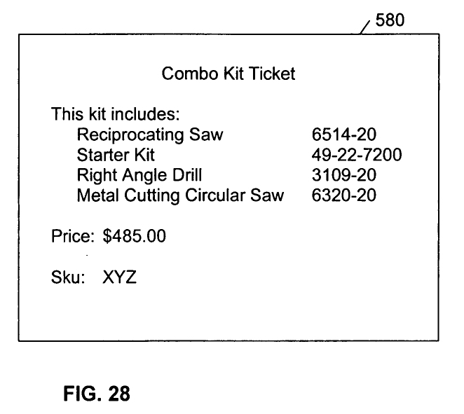

The screen 384 also includes a suggestion section 412. The software program 316 includes an algorithm that can make suggestions to the user based on the selected tools and components in the combo kit. The algorithm can also make suggestions to the user based on user information that was previously acquired, such as information acquired from previous purchases, browsing episodes, estimated use, etc. The algorithm can maximize the user's purchasing power by generating suggestions to the user to add and/or remove certain tools and/or components from the combo kit. If the user likes the suggestion, the user can select the particular selection and the selection section 400 and price section 408 will automatically update based on the tools and/or components to be added or removed according to the suggestion. The screen 384 also includes a purchase button 414, which when clicked generates a combo kit configuration report (discussed below and see FIG. 28).

If the user selects the rent/lease option 332 from screen 324 (FIG. 11) and after selecting a location for pick-up of the rented item, screen 416 is displayed. A user can rent or lease a tool and/or a combo kit by selecting the appropriate option 420 or 424 on screen 416 (FIG. 20). If the user includes a user name and a password on screen 304, the screen 416 can include a previous rentals/leases section 428 that lists the previous tools and/or combo kits that the specific user rented and/or leased at some earlier time. The user can rent and/or lease one or more of the items listed in the previous rentals/leases section 428 by selecting a rent button 430 or a lease button 432. After selecting one of the items in the previous rentals/leases section 428, the user is transferred to the screen(s) described below to complete the rental and/or lease process.

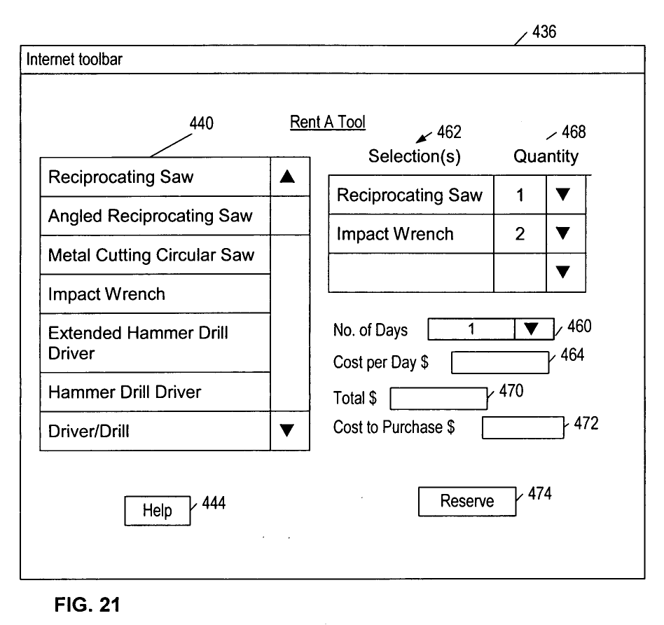

A listing of all available tools appears in screen 436 when the user selects the rent-tool option 420 as illustrated in FIG. 21. The screen 436 includes a tool section 440 that lists all of the available tools at the selected location. The user can click on the tool in the tool section 440 to learn more about the specifications and uses of the selected tool. By clicking on one of the tools in the tool section 440, other fields (described below) are populated with cost related information. The user can select more than one tool to rent as indicated in the rental selection section 462. When more than one tool or item has been selected, the software program 296 initiates a combination kit configuration analysis to determine the cost to rent the multiple items as a combination kit providing for a discount than separately renting the multiple items. This analysis generates a single price for the multiple items and configures the items as a combination kit.

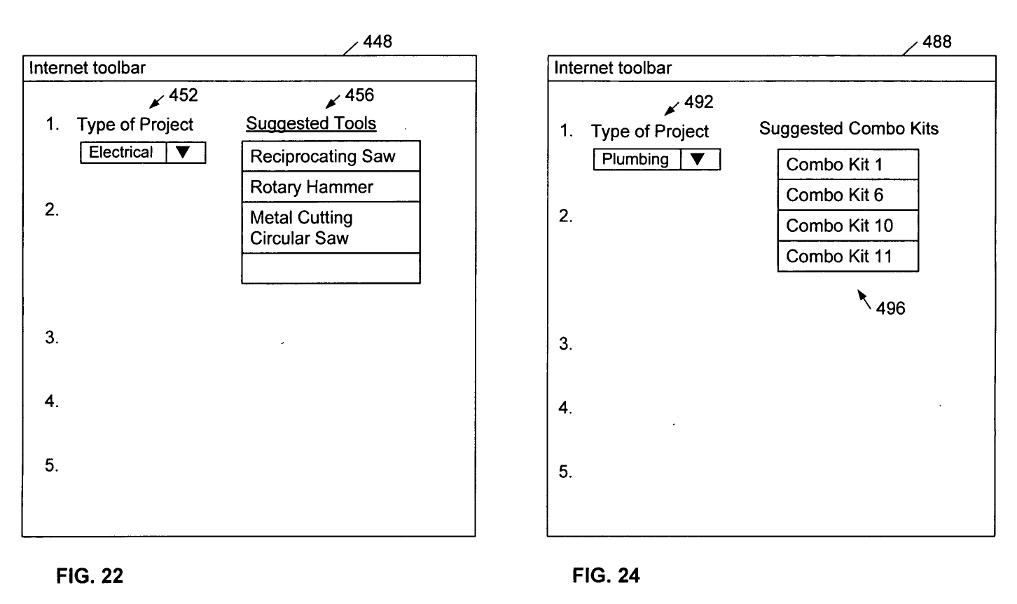

The user can also click on a help button 444 to initiate a suggestion algorithm in the event the user cannot decide or does not know which tool should be used for the particular project. If the user clicks on the help button 444, screen 448 appears as illustrated in FIG. 22. The screen 448 includes a question section 452, which provides a list of questions. The initial question requests the type of project to be undertaken. The user can select from a variety of project types and the various tools that can be used for that type of project appear in a suggested tools section 456. The remaining questions are based on the type of project selected in order to narrow down the suggested tools. After each question is answered, the suggested tools section 456 is updated to reflect the type of tool(s) that can be used to accomplish the identified project. The user can answer as many questions as desired or make a selection at any time from one of the tools in the suggested tools section 456. After selecting one or more of the tools in the suggested tools section 456, screen 436 (FIG. 21) appears and the user can proceed as described below.

The screen 436 also includes a selection 460 for the number of days for the rental. The screen 436 also includes a cost section 464, which indicates the cost per day to rent the selected tool based on the number of days selected in the selection 460, a total cost section 470, which indicates the total cost to rent the tool for the number of days selected in the selection 460, and a quantity section 468. The screen 436 can include a cost to purchase section 472 that the user can view to determine whether they may want to purchase the item rather than rent the selected item. The user can reserve the selected tool(s) by selecting or clicking on a reserve button 474. After clicking on the reserve button 474, the user may be asked to enter additional information regarding the requester's name, address, phone number, credit card number, time of pick-up and/or other identification and contact information. In addition, at this time, the user can be asked whether delivery of the reserved item, along with date and time, is desired. The software program 316 can generate a reservation number that the user can write down or print out to take to the store to pick up the rental tool and/or use to confirm delivery. The software program 316 also generates an alert to store personnel to set aside or reserve the selected tool. The software program 316 can also generate an e-mail notification or confirmation of the rental or lease that can be transmitted to the user provided an e-mail address was provided or is stored in the user's profile upon registration. The software program 316 can also generate an e-mail notification that can be transmitted to the user provided an e-mail address was provided or is stored in the user's profile upon registration as a reminder if the reserved item was not picked up at the scheduled date/time.

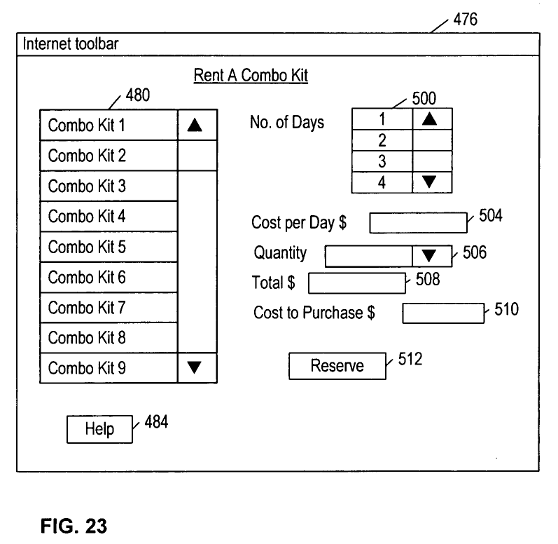

A listing of all available combo kits appears in screen 476 when the user selects the rent-combo kit option 424 as illustrated in FIG. 23. The screen 476 includes a combo kit section 480 that lists all of the available combo kits at the selected location. The user can click on the combo kit in the combo kit section 480 to learn more about the tools and other components in the combo kit, the specifications and uses of the various tools in the combo kit. The user can also click on a help button 484 to initiate a suggestion algorithm in the event the user cannot decide or does not know which tool should be used for the particular project. If the user clicks on the help button 444, screen 488 appears as illustrated in FIG. 24. The screen 488 includes a question section 492, which provides a list of questions. The initial question requests the type of project to be undertaken. The user can select from a variety of project types and the various combo kits that can be used for that type of project appear in a suggested combo kits section 496. The remaining questions are based on the type of project selected in order to narrow down the suggested combo kits. After each question is answered, the suggested combo kits section 496 is updated to reflect the type of combo kits(s) that can be used to accomplish the identified project. The questions can include the number of workers on the job or the number of workers that need one or more of the tools in the combo kit and the rate of use per day to determine the number of batteries and/or battery chargers needed in the kit. The user can answer as many questions as desired or make a selection at any time from one of the combo kits in the suggested combo kits section 496. After selecting one of the combo kits in the suggested combo kits section 496, screen 476 (FIG. 23) appears and the user can proceed as described below.

The screen 476 also includes a selection 500 for the number of days for the rental. The screen 476 also includes a cost section 504, which indicates the cost per day to rent the selected combo kit based on the number of days selected in the selection 500, a total cost section 508, which indicates the total cost to rent the combo kit for the number of days selected in the selection 500, and a quantity section 506. The screen 476 can include a cost to purchase section 510 that the user can view to determine whether they may want to purchase the combo kit rather than rent the selected combo kit. The user can reserve the selected combo kit by selecting or clicking on a reserve button 512. After clicking on the reserve button 512, the user may be asked to enter additional information regarding the requester's name, address, phone number, credit card number, time of pick-up and/or other identification and contact information. In addition, at this time, the user can be asked whether delivery of the reserved combo kit, along with date and time, is desired. The software program 316 can generate a reservation number that the user can write down or print out to take to the store to pick up the combo kit. The software program 316 can also generate a combination kit configuration report (described below) that lists the particular tools and/or other items in the selected combo kit. The software program 316 also generates an alert and/or a copy of the combination kit configuration report to store personnel to set aside or reserve the items in the selected combo kit. The software program 316 can also generate an e-mail notification or confirmation of the rental or lease that can be transmitted to the user provided an e-mail address was provided or is stored in the user's profile upon registration. The software program 316 can also generate an e-mail notification that can be transmitted to the user provided an e-mail address was provided or is stored in the user's profile upon registration as a reminder if the reserved item was not picked up at the scheduled date/time.

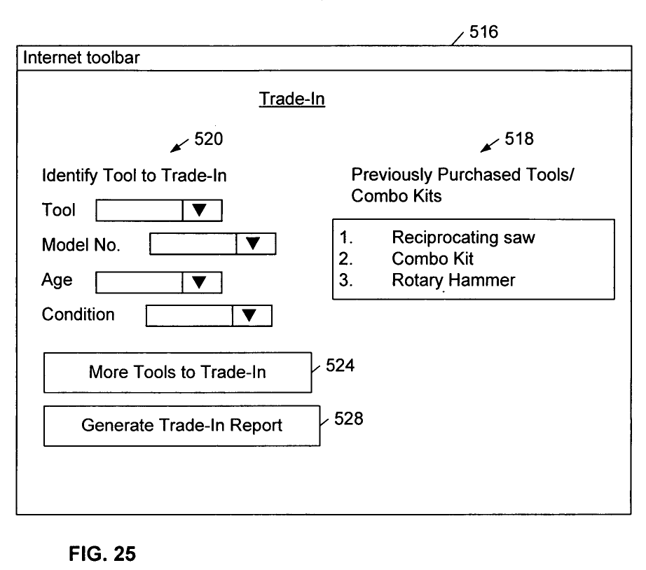

If the user selects the trade-in option 336 on screen 324 (FIG. 11), screen 516 is displayed as illustrated in FIG. 25. The user can trade-in various tools for new or updated versions of the tools or for other tools. For example, the user may wish to trade in a tool(s) that is compatible with an 18V battery for a tool(s) that operates with a different voltage battery (e.g., a 28V battery). The screen 516 includes a tool identification section 520, which includes a plurality of items for the user to describe the tool to be traded-in. For example, the tool identification section 520 can include questions related to the type of tool, model number of the tool, age of the tool, and condition of the tool. The screen 516 includes a previously purchased tools/combo kits section 518 from which the user can select an item for trade-in. If the user selects an item from the previously purchased tools/combo kits section 518, the tool identification section 520 can be automatically populated with the requested identification information. The system 280 can store transaction information of previously purchased items such that when the user wishes to trade-in certain tools and/or combo kits, the trade-in process is easier to identify the particular items and when they were purchased to identify age and/or condition. The software program 316 can require all or some of the questions in the tool identification section 520 to be completed. Additional questions can also be asked of the user.

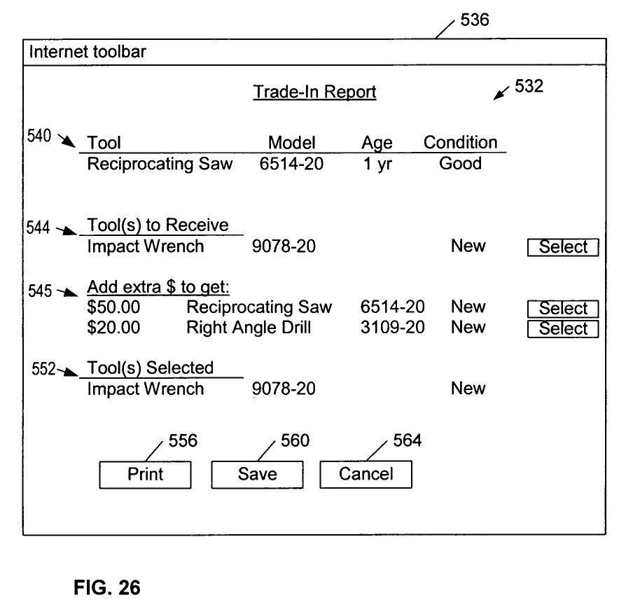

The screen 516 also includes a more tools to trade-in button 524. If the user clicks on this button 524, another tool identification section 520 will be displayed to allow the user to enter information related to a second tool that may be traded-in. The user can enter tool identification information for as many tools as is desired to trade-in by clicking on the more tools to trade-in button 524. When the user has completed the tool identification section(s) 520, the user clicks on a generate trade-in report button 528. The software program 316 generates a report 532 as illustrated on screen 536 in FIG. 26.

The report 532 includes an indication of the tool(s) to be traded-in in a tool trade-in section 540. The report 532 also includes a tool(s) to receive section 544, which identifies the particular tool or item that the user can get for the trade-in. The tool(s) to receive section 544 can include one or more tools depending on the tool to be traded-in. The report 532 also includes an add extra money section 548, which identifies additional options for the user. The user can add additional money to get a different tool than the tool(s) identified in the tool(s) to receive section 544. The user makes a selection to receive the tool(s) suggested or to add extra money for a tool by clicking on a select button next to the desired option. The tool(s) selected to receive appears in a tool(s) selected section 552. The user can print the report by clicking on a print button 556, save the report by clicking on a save button 560, or cancel the report by clicking on a cancel button 564. The software program 316 transmits a copy of the report to the selected store location.

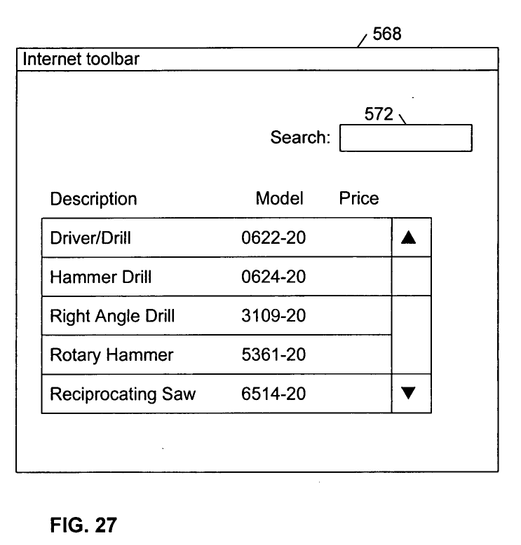

If the user selects the browse option 340, on screen 324 (FIG. 11), screen 568 is displayed as illustrated in FIG. 27. The screen 568 includes a listing of all tools, combo kits, starter kits, accessories, batteries, battery chargers, etc. The screen 568 includes a search option 572. The user can input keywords, phrases, and numbers in the search option 572 to conduct a search for a particular item. The item(s) that satisfy the search criteria can appear at the top of the list. The user can select or click on one of the entries to obtain additional information regarding the item, such as a specification, warranty and uses of the item.

In one independent aspect of the invention, the user interacts with the combo kit selection system 280 to order the combo kit, tools, accessories, etc. via the Internet by utilizing a “shopping cart” and/or shopping page as is known in the art. For example, the user can click on the purchase button 414 to place the combo kit or other items in the “shopping cart” and then proceed to a payment and shipping screen.

In other independent aspects of the invention, the user interacts with the combo kit selection system 280 to print out a combo kit configuration report 580 as illustrated in FIG. 28. The user can interact with the combo kit selection system 300 as described above. The combo kit configuration report 580 can be printed at the computer terminal 308 and taken to the store to purchase the combo kit. If the computer terminal 308 is located in the store, the user can take the combo kit configuration report 580 to the checkout for purchase. The combo kit configuration report 580 includes one identification number for all of the items in the combo kit. The combo kit configuration report 580 saves time at the check-out, but still preserves the identification of the items in the combo kit for employee use to gather the items in the combo kit. Alternatively, the user can manually select specific items to create a combo kit and store personnel can either manually or electronically generate the combo kit configuration report 580 with or without the combo kit selection system 280.

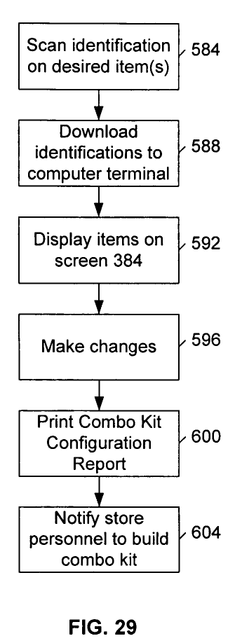

In another independent embodiment of the invention, a store can display all items, such as power tools 62, 62′, starter kits, batteries 66, 66′, battery chargers 70, 70′, 74, 74′, 78, 80, 82, and accessories that can be combined to create a combo kit. In one aspect, each item on display can include a unique identification tag (e.g., bar code). The flow chart in FIG. 29 illustrates a method of generating a combo kit according to one independent aspect of the invention. A person can create a combo kit by utilizing an electronic reader (e.g. bar code reader) to scan (at 584) the unique identifications on the items to create a combo kit. The person takes the electronic reader to a computer terminal 288, such as an in-store kiosk, to download (at 588) the scanned identifications into the software program 296. The software program 296 processes the downloaded information to instruct the computer terminal 288 to display (at 592) screen 384 (FIG. 19) including the selected items in the selection section 400 of screen 384. The person can make changes (at 596) to the items in the combo kit. The user selects the purchase button 414 on the screen 384 to print (at 600) the combo kit configuration report 580, which can be taken to the checkout for payment. After payment of the combo kit, the system 280 notifies (at 604) store personnel to gather the tools and other items to build the combo kit.

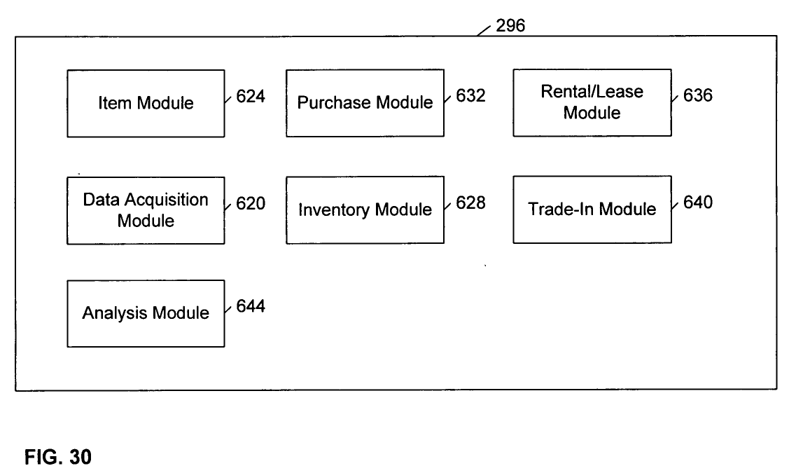

Referring to FIG. 30, the software program 296 of the combo kit selection system 280 (FIG. 9) can include a data acquisition module 620, which can acquire data from the user when the user answers the questions upon registration. The data acquisition module 620 can also acquire transaction data, such as purchase data, rental data, lease data, and trade-in data. The data acquisition module 620 can acquire additional data.

The software program 296 can also include an item module 624, which maintains all of the items in the database 300. The item module 624 maintains an up-to-date list of all items, such as tools, combo kits, starter kits, batteries, battery chargers, accessories, carrying cases, and consumables. The item module 624 can be updated when new items are available or when items are no longer available. The item module 624 can maintain the information associated with the tools, combo kits, starter kits, batteries, battery chargers, accessories, carrying cases, and consumables, such as specification information, warranty information, etc.

The software program 296 can also include an inventory module 628, which tracks and maintains the location and quantity of each of the items available through the combo kit selection system 280. The inventory module 628 can track which items are available at which location (e.g., retail store, warehouse, etc.) for purchase and/or rental/lease. The inventory module 628 can also inform users when shipments are expected to arrive and at which locations if monitoring the system 280 for availability of a specific item.

The software program 296 can further include a purchase module 632, which provides information related to costs associated with purchasing any of the tools, combo kits, starter kits, batteries, battery chargers, accessories, carrying cases, and/or consumables. The purchase module 632 can configure and generate the combo kit configuration report 580. The purchase module 632 can also generate the notification to the store personnel to gather the tools and other items to build the combo kit after the items have been purchased.

The software program 296 can also include a rental/lease module 636, which maintains information related to the tools and combo kits for rental/lease. The rental/lease module 636 can maintain information related to the availability of each of the tools and combo kits at each location. The rental/lease module 636 can also monitor the length of time each tool and/or combo kit has been used in order to perform preventative maintenance as necessary. The rental/lease module 636 can generate and transmit confirmation and reminder notifications (e.g., via e-mail) to the users.

The software program 296 can include a trade-in module 640, which maintains information stored in the database 300 related to previous purchases and operates an algorithm to determine the value of an item being traded in exchange for another item. The trade-in module 640 can determine the age of an item being traded in if the item was previously purchased at the combo kit selection system 280.

The software program 296 can also include an analysis module 644, which can analyze separate data and combine it to generate a configuration report. For example, the software program 296 allows the user to select a plurality of items from a list, and the analysis module 644 analyzes the data to generate a combination kit that comprises the selected plurality of items at a single purchase or sales price.

The software program 296 can include additional modules and each of the modules discussed above can include additional functionalities than described.

One or more independent features and independent advantages of the invention are set forth in the following claims.

1. A method of purchasing a combination kit, the method comprising:
selecting a plurality of items;
generating a purchase request based on a configuration of the plurality of items as a combination kit; and
purchasing the combination kit.

2. The method of claim 1, wherein the act of selecting a plurality of items includes selecting one of a power tool, a battery, a battery charger, a starter kit, an accessory, a consumable, and a carrying case.

3. The method of claim 1, wherein the plurality of items includes at least one power tool and at least one starter kit.

4. The method of claim 1, wherein the plurality of items are the same items.

5. The method of claim 1, wherein the plurality of items includes both cordless power tools and corded power tools.

6. The method of claim 1, wherein the combination kit is a single purchase unit.

7. A computer program embodied by a computer readable medium capable of being executed by a computer, the computer program for use in a combo kit selection system, the computer program comprising:
an item module operable to generate a list of items; and
a module operable to configure a plurality of selected items from the list of items as a combination kit.

8. The computer program of claim 7, wherein the module operable to configure is operable to generate a combination kit configuration report including a single price for all of the selected items.

9. The computer program of claim 7, wherein the list of items includes one of a power tool, a battery, a battery charger, a starter kit, an accessory, a consumable, and a carrying case.

10. The computer program of claim 7, further comprising an inventory module operable to track an availability and a location of each of the items that comprise the list of items.

11. The computer program of claim 7, wherein the module operable to configure includes a purchase module operable to generate a combination kit configuration report including a single price for all of the selected items.

12. The computer program of claim 7, wherein the module operable to configure includes a rental module operable to present a list of items capable of being rented and to calculate a cost of renting an item.

13. The computer program of claim 7, further comprising a trade-in module operable to automatically generate a report including an identification of a first item being traded-in and a second item being received in exchange for the first item.

14. The computer program of claim 11, wherein the trade-in module includes a suggestion module operable to automatically provide a list of items that can be obtained when the first item is traded-in in addition to a specified monetary amount.

15. A method of automatically configuring a combination power tool kit, the method comprising:
selecting a plurality of items;
determining whether the selected items qualify for a combination discount;
if the selected items qualify for a combination discount, generating a combination kit configuration report including a single price for all of the selected items; and
if the selected items do not qualify for a combination discount, generating a suggestion to modify at least one of the selected items.

16. The method of claim 15, wherein the act of selecting a plurality of items includes selecting one of a power tool, a battery, a battery charger, a starter kit, an accessory, a consumable, and a carrying case.

17. The method of claim 15, wherein the plurality of items includes at least one power tool and at least one starter kit.

18. The method of claim 15, wherein the plurality of items are the same items.

19. The method of claim 15, wherein the act of determining whether the selected items qualify for a combination discount includes determining a total number of the items selected and a total cost of the selected items.

20. The method of claim 15, wherein the plurality of items is organized based on one of price and profession.
